(19) United States
(12) Patent Application Publication
(10) Pub. No.: US 2009/0216859 A1
(43) Pub. Date: Aug. 27, 2009

(54) METHOD AND APPARATUS FOR SHARING CONTENT AMONG MULTIPLE USERS

(76) Inventor: Anthony James Dolling, San Jose, CA (US)

Correspondence Address: BLAKELY SOKOLOFF TAYLOR & ZAFMAN LLP, 1279 OAKMEAD PARKWAY, SUNNYVALE, CA, 94085-4040, US

(21) Appl. No.: 12/273,705

(22) Filed: Nov. 19, 2008

Related U.S. Application Data
(60) Provisional application No. 61/030,879, filed on Feb. 22, 2008.

(51) Int. Cl. G06F 21/00; G06F 15/16

(52) U.S. Cl. 709/218; 726/4

(57) ABSTRACT

Techniques for sharing content among multiple users are described herein. According to one embodiment, content is received from an owner to be shared among multiple members of one or more communities, where the owner defines the one or more communities. In response to the received content, a privacy level associated with the content to be shared is determined, where the privacy level is assigned by the owner. A trust level associated with each member of the one or more communities is determined, where each member is associated with a trust level assigned by the owner previously to represent a relationship between each member and the owner. The content is shared among selected members of the one or more communities if trust levels of the selected members and the privacy level associated with the content satisfy a predetermined relationship. Other methods and apparatuses are also described.

### RELATED APPLICATION

This application claims the benefit of U.S. Provisional Patent Application No. 61/030,879, filed Feb. 22, 2008, which is incorporated by reference herein in its entirety.

### FIELD OF THE INVENTION

The present invention relates generally to digital content sharing. More particularly, this invention relates to digital content sharing based on how users interact in a real social environment versus typical network based “social environments”.

### BACKGROUND

Whilst each relationship is unique, people group relationships around activities i.e. work family, friends, teams etc., where there is a commonality of purpose. A typical person maintains separate relationships within these groups on the basis of who each person is and the reason for the group itself. An individual may maintain a large social group in the workplace, another social group for family and another for a particular sport they may play. Most individuals maintain at least 7-8 natural social groups whether they realize it or not.

In the real world each person consciously or subconsciously establishes a level of trust with each person on a group-by-group basis. For example, you may share information (pictures, jokes, stories, etc.) with your work colleagues that you would not share with your boss. You may share certain personal family information with only a subset of your extended family. This is how social interaction has happened for thousands of years.

It is interesting to note that for any individual relationship there can be more that one group relationship. Take for example a work colleague, with whom one might want to share work related information. The work colleague might also be on a hockey team, where one may want to share hockey related files (Video clips, Newsletters), as shown in FIG. 1. The level of trust between these two individuals may be different in the context of work versus in the context of the hockey team. Furthermore, the information shared in the context of work may be different from the information shared in the context of the hockey team. However, there has been a lack of effective environment for such purposes available using a network such as the Internet, a local area network (LAN) or private wide area network (WAN)

### SUMMARY OF THE DESCRIPTION

Techniques for sharing content among multiple users are described herein. According to one embodiment, content is received from an owner to be shared among multiple members of one or more communities, where the owner defines the communities and adds other members to the communities, where the same member could be added to multiple communities. In response to the received content, a privacy level associated with the content to be shared is determined, where the privacy level is assigned by the owner. A trust level associated with each member of the one or more communities is determined, where each member is associated with a trust level assigned by the owner previously to represent a relationship between each member and the owner. The content is shared among selected members of the one or more communities if trust levels of the selected members and the privacy level associated with the content satisfy a predetermined relationship.

Other features of the present invention will be apparent from the accompanying drawings and from the detailed description which follows.

### BRIEF DESCRIPTION OF THE DRAWINGS

The present invention is illustrated by way of example and not limitation in the figures of the accompanying drawings in which like references indicate similar elements;

FIG. 1 is a diagram illustrating certain configurations of user groups;

FIG. 2 is a block diagram illustrating an example of a system configuration according to one embodiment of the invention;

FIG. 3 is a block diagram illustrating an example of information base configuration according to one embodiment of the invention;

FIGS. 4A-4C illustrate examples of data structures which may be used with certain embodiments of the invention;

FIGS. 5A-5F are diagrams illustrating examples of user groups with certain trust levels according to certain embodiments of the invention;

FIG. 6 is a flow diagram illustrating an example of process for sharing content among multiple users according to one embodiment of the invention;

FIG. 7 is a block diagram illustrating an example of a system which may be used with one embodiment of the invention;

FIG. 8 is a flow diagram illustrating one embodiment of a process for sharing a content with a user;

FIG. 9 is a block diagram illustrating an example of a system which may be used with another embodiment of the invention;

FIGS. 10A-10G are diagram illustrating examples of certain user interfaces which may be used with embodiments of the invention; and

FIG. 11 illustrates one example of a computer system which may be used with an embodiment of the invention.

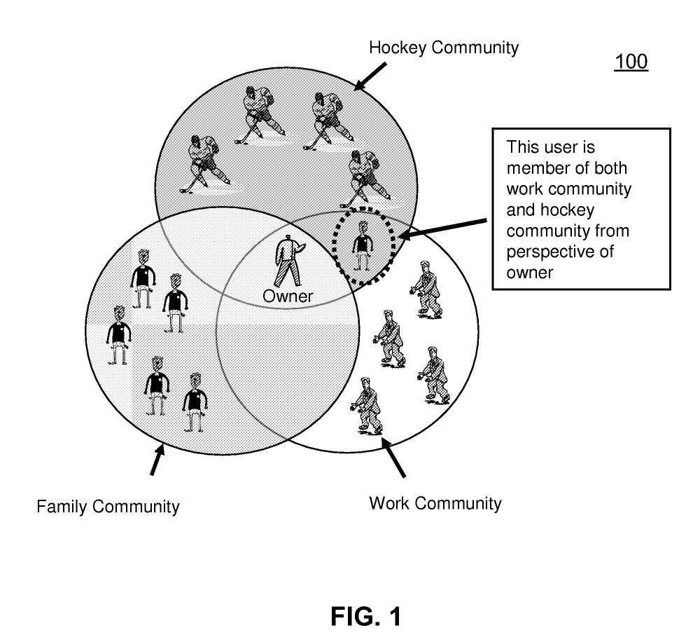

### DETAILED DESCRIPTION

In the following description, numerous details are set forth to provide a more thorough explanation of embodiments of the present invention. It will be apparent, however, to one skilled in the art, that embodiments of the present invention may be practiced without these specific details. In other instances, well-known structures and devices are shown in block diagram form, rather than in detail, in order to avoid obscuring embodiments of the present invention.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification do not necessarily all refer to the same embodiment.

According to one embodiment, multi-user sharing technology (MUST) is a concept that allows an individual to share files (e.g., Media, Text, Graphics, Photos etc) and live media/data (e.g. webcam, sensors, alarm systems, etc.) with acquaintances, friends, work colleagues, family etc in a way that mirrors true-life social interaction. MUST is a unique system that allows users to interact over a network following how normal social interaction is done in a real world. In one embodiment, a system is established for sharing content or files and live media/data among users, which reflects real social interaction and the need for privacy. Users are able to access, view, and share files and live media/data from any device that is connected to the network including personal computers, mobile devices (e.g., phones), PDA (personal digital assistant), etc.

A unique aspect of MUST is that it reflects the way that real social interaction happens. This is in contrast to how other network-based solutions are currently implemented. According to certain embodiments, each individual could have one or more relationships with other people; however, the relationship that any individual has with any other single individual may be unique.

According to one embodiment, MUST implements this “real social interaction” in a network environment. MUST allows a user to categorize all of his/her relationships into meaningful (in view of the user) groups and allows any individual relationship to be defined over more than one group.

According to certain embodiments of the invention, the heart of how MUST recreates real social interaction in a networking environment is through the implementation of a privacy/trust relationship concept. In one embodiment, for each individual within each group, a trust level is established and assigned to reflect a confidentiality that exists between the user and that individual. This may change for an individual dependant upon a specific group that the individual belongs to.

For example, a work colleague, with whom a person would openly share work files with, may only be a player on the hockey team, while a person, as captain, may not want to share coaching suggestions with that player, but only with an assistant captain and coaches. Thus the work colleague would have a lower trust level within the hockey team group than the trust level the work colleague would have in the work group. Thus, the same individual would have different trust levels in different groups (e.g., the work group and the hockey team in this example).

As any file is published to MUST, according to one embodiment, a privacy level is assigned for any group to which it is intended for publication. In one embodiment, only users within the groups to which it is published, with a trust level above or equal to a privacy level set will be able to view, access, and/or download the shared content. This allows a user to have complete confidence that only people that the user wants to be able to see the shared content, will even know the shared content exists.

According to one embodiment, an example of a system includes at least two components: MUSTgate (e.g., a server component) and MUSTfile (e.g., a client component). The MUSTgate maintains the user and group relationships for all users. It determines what is permitted and what is not permitted based on the user-established relationships, groups and trust levels that are maintained in its one or more databases. The MUSTfile is the client application that interacts with and uses the MUSTgate (over a network such as the Internet). The MUSTfile component can run on a variety of platforms. The MUSTfile facilitates the file/information sharing application among multiple users.

It should be noted that for the purposes of simplicity, throughout this application, a file is utilized as a generic term. The entire system is designed to allow the sharing of any type of data (e.g. content, resources), such as video, audio or other forms of streaming data. The sharing of sensor information such as cameras, security systems, “Smart Home” devices, etc. may also be supported by MUST. For example, a user with a Web cam can choose to share the information (in this case a streaming video feed) using all concepts and methodologies that form the basis of MUST.

For the purposes of illustration, a user is referred to as a person or client using the system. A user can use the system as an owner or a friend. An owner is referred to as a user who establishes relationships, groups, and trust levels with other users. An owner may post or publish a file to be shared with select users. All users can be owners. A friend is referred to as a user who accesses the system to view a shared file. These files are posted by other owners. The basis for what files a friend can access is established by the owners. All users can be friends but only when the relationship is established by one or more owners. A group (also referred to as a community or society herein) is referred to a group of one or more friends that are associated by a particular owner. A group may be created or known only by the owner. That is, a group or community is only relevant to an owner who creates it. A user as a member of a particular group may not be aware of which group or groups the user belongs to (e.g., group name, etc.) if the user is not an owner who creates the group or groups.

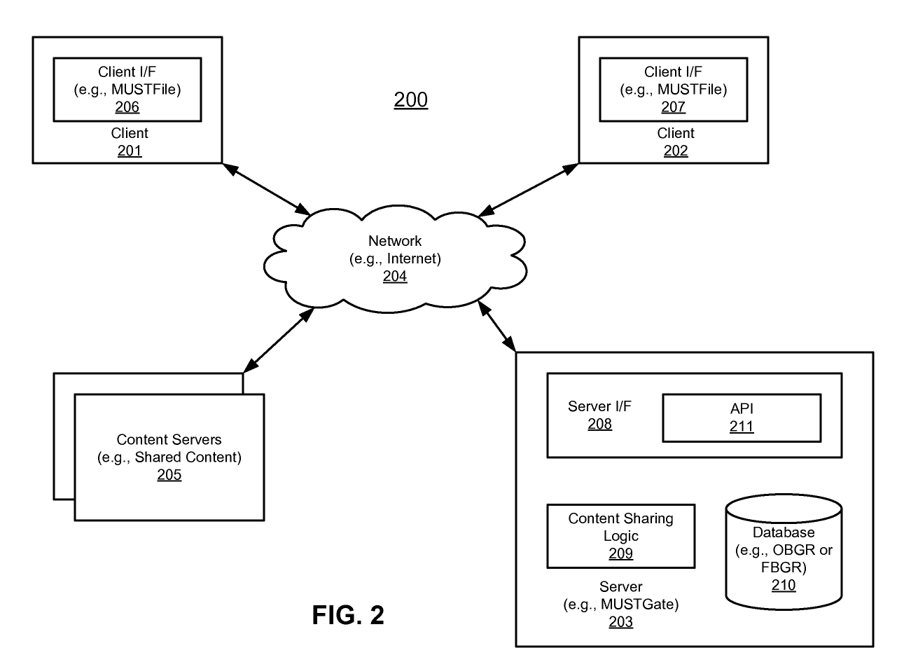

FIG. 2 is a block diagram illustrating a MUST system according to one embodiment. Referring to FIG. 2, system configuration 200 includes one or more clients 201-202 communicatively coupled to a MUST server 203 over a network 204. Clients 201-202 may be any of the client devices described above. Each of the clients 201-202 includes a client application 206-207 that is configured to access server 203 over network 204. Network 204 may be a wide area network (WAN) such as the Internet or alternatively, a local area network (LAN) such as Intranet of an organized entity such as an enterprise. Network 204 may be a single network or a combination of multiple networks of different configurations.

In one embodiment, server 203 includes a server interface module 208 (also referred to as a MUSTgate module), a content sharing logic 209, and one or more databases 210. According to one embodiment, note that, although a single server 203 is shown; however, multiple servers may be implemented to allow files to be identified as available for other users to view or access content being shared. Components 208-209 may be implemented as a single module or multiple modules. According to one embodiment, server interface module 208 allows clients 201-202 to interact with server 203. Module 208 interacts directly with the user client (system 206 & 207) and can support generic user interfaces (e.g., Web interface) to allow clients 201-202 to interact with server 203 when using equipment that does not have the MUST client running on it. Content sharing logic 209 is used to maintain real time information of all active users necessary to facilitate the transfer of files or other information, which may be stored in database 210 or alternatively in a third party storage 205 or on the client device.

There may be full server redundancy built into the system 200. It may support centralized data (or facilitate connectivity) to central data storage (e.g., storage 205 or a backend storage server) to allow clients 201-202 to optionally store content. Server Interface 208 may include application programming interfaces (API) 211 to allow other programs to access (e.g., link in) the underlying structures. For example, other applications may be communicatively coupled to the system as a plug-in application. System 200 maintains a sufficient storage space that satisfies the storage requirements of the users (and the associated platforms), in which the files may be stored at local storages of clients 201-202 or MUSTgate's servers 203, or alternatively, a third party storage such as server 205. Server 203 also maintains user's preferences and cost implications of when and how to transfer files, etc. in database 210.

System 200 may use a network such as the Internet 204 for locating the files and transferring them for sharing purposes. The server 203 operates in a transparent and seamless manner. Server 203 may maintain relevant information and interwork with client software (MUSTfile) 206/207 to allow the transfer of files or information on a unicast (e.g., peer-to-peer basis) or a multicast manner. Server 203 may include the ability to convert content media formats dependant on the platform it is transferring the file to. Server 203 may understand the platforms on which users are operating. Server 203 may allow the users to use system 200 to address files stored on users' own platforms.

According to one embodiment, a MUSTfile component (components 206-207) includes both a user interface and client software that interface with MUSTgate 208 of server 203. The client component should be simple and intuitive to use and it should work on all platforms such as Microsoft Windows XP/2000/Vista and Windows CE platforms. Other platforms such as Mac OS, Linux, Symbian etc. should also be supported to allow access to and from mobile devices (phones, PDA, etc.) System 200 may further support the necessary peer-peer networking capabilities (e.g., tunneling technology, encryption, etc.) using information provided through the Server Interface 208 MUSTgate to allow direct sharing of files/data between user devices. When a user initiates a request to view, download, and/or stream a file or content, the MUSTfile 206-207 will receive necessary access of the requested file or content, such as authentication and end point information, etc. from the MUSTgate 208 and initiate the file transfer.

A trust level represents a relationship between an owner and a particular friend of a particular group. A trust level may be ranging from 0-9, where 0 means no trust level and 9 is the highest trust level. A trust level is established between an owner and a friend and set by the owner on a group basis. This means a particular friend as a member of multiple groups may have different trust levels in each group. A privacy level represents an access privilege level associated with a particular group in which particular content is shared. In order for a friend to access a shared file, the trust level of the friend has to meet or exceed the privacy level of the shared file applied by the owner for the particular group associated with the friend. A privacy level may be ranging from 0-9, where 0 means no privacy level and 9 is the highest privacy level. The owner sets a privacy level on a file on a group by group basis.

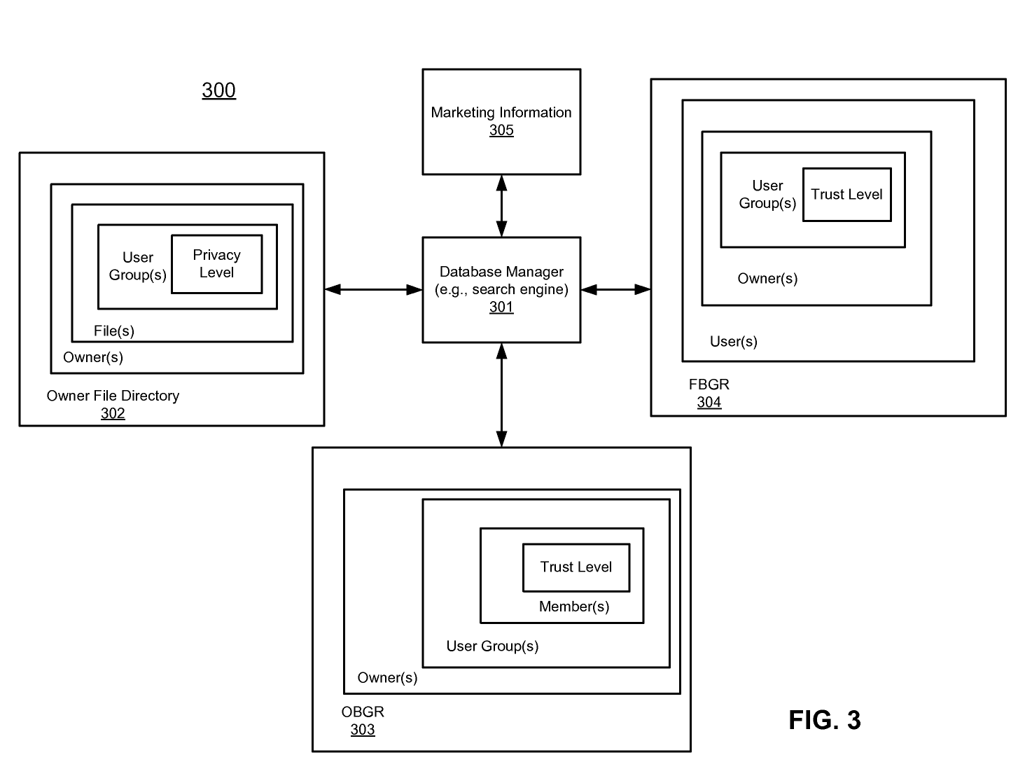

According to certain embodiments of the invention, one or more databases may be implemented. FIG. 3 is a block diagram illustrating an example of database configuration according to one embodiment of the invention. For example, database system 300 may be implemented as part of server 203 of FIG. 2. Referring to FIG. 3, system 300 includes database manager or logic 301 for managing a variety of information bases, such as user file directory 302, OBGR 303, FBGR 304, and marketing information base 305.

For example, a relational database may be implemented, including owner identification (e.g., username, real name, password, address, email address, whatever identification required to facilitate transfer/sharing of information such as current IP address/port or other network based identifier, server information, other platform information) and owner marketing information (e.g., age, sex, interests). This part of the database requires complete security and only is available to the owner or to the facilitator of MUST for marketing/advertising purposes with expressed approval of the owner. The more marketing information obtained the greater the value of the information.

The database(s) may further include owner defined groups (e.g., group identifier, family, friends) and owner based group relationships (OBGR) (e.g., group identifier, friend identifier, friend server info, real name, username, trust level in that group, and menu order in group). Each group member (friend) may be a member of more than one group for any single user (owner) with differing levels of trust, as configured within a friend based group relationship (FBGR) (e.g., friend identifier, owner identifier, group identifier, trust level) and file directory for each user (e.g., filename. Description, date, file type, and location of file such as URL) and directory information (e.g., groups posted to, privacy level within that group). It might also include another privacy level available for enhancements such as read only level.

Referring back to FIG. 3, system 300 may be required to operate over many servers with sub sets of the database located at each server with full server redundancy built in. Note that database system 300 may be implemented as a single database or alternatively, as multiple databases, which may be stored in a single server or multiple servers. In one embodiment, a set of instructions to use the database to identify and undertake may be needed as follows:
The owner
The owner's groups
The owners friends
The files that that group can see
The Privacy level of that file
The Trust level of each friend within that group
Connect any friend who had a Trust level equal or greater than the Privacy level.

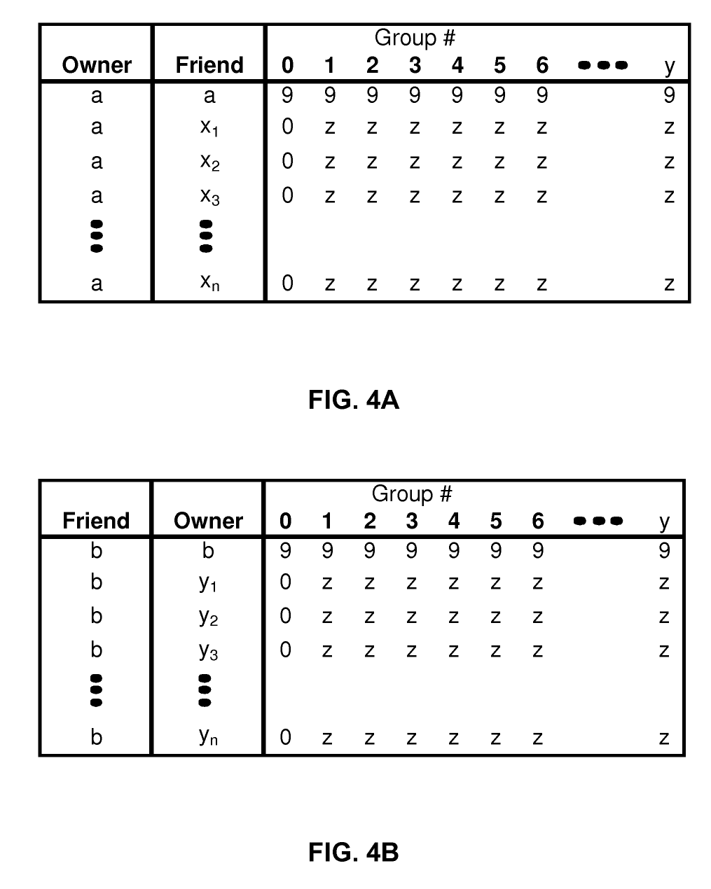

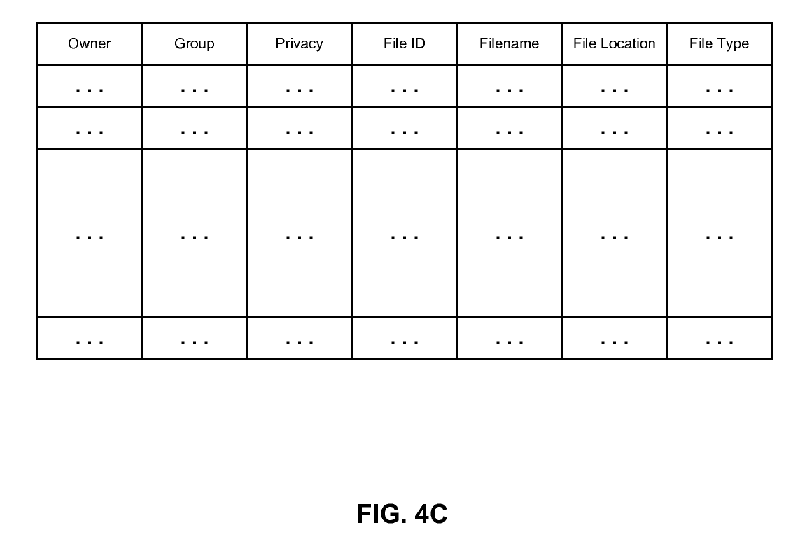

As can be seen above, database system 300 includes relationship and groups with respective trust levels created by a particular user. This is called “owner based groups and relationships” or OBGR 303. This table is a result of relationships created by the user. System 300 further includes the resulting relationships on a per user basis. This is referred to as “friend based groups and relationships” or FBGR 304. This table is a result of the relationships established by others. System 300 further includes data structure for each file submitted by a user (e.g., similar to the one as shown in FIG. 4C).

In one embodiment, for the purposes of illustration, an example of an OBGR data structure is shown in FIG. 4A, where “a” represents an owner; “xₙ” represents a friend (e.g., another user) that the owner “a” has established a relationship with; and “z” represents a trust level for each relationship (default is 0) for each group the owner has associated the user with. In one embodiment, an example of an FBGR is shown in FIG. 4B, where “b” represents a friend; “yₙ” represents an owner that has established relationships with a friend “b”; and “z” represents a trust level for each relationship (default is 0) for each group the owner has associated the user with.

In one embodiment, each owner can post or publish information to MUSTgate on the basis of the friends and groups the owner has established. When information (e.g. a file) is posted to MUSTgate, the following attributes may be established:
<file name>[owner, group, privacy level, location, filetype]
   where
Owner=owner identifier that identifies the owner as defined earlier
Group=the group number or identifier associated with the group the owner posts the file to
Trust Level=the trust level the user puts on that particular file
Location=the location of the file, e.g. a local file path or a URL (universal resource locator)
Filetype=the type of file (e.g. text, video format, picture, music, etc.)

As a user first joins the system, according to one embodiment, the system may create both an OBGR and an FBGR table associated with the user. Initially, the only relationship the user will have will be with himself that will be defined as group 0. No friend can ever join group 0 as this is to enable the owner to see his/her own files on other devices. The FBGR/OBGR reflects this by forcing trust level 0 in group 0 for all subsequent relationships that are established. As the user establishes relationships, groups and trust levels, the OBGR will be updated accordingly. The FBGR may be updated as relationships are established by other users with the user in question. The FBGR provides the relationships that are used to establish what information a particular user can see. Multiple FBGR may need to be updated based on a single update of an OBGR.

This is best illustrated with a number of examples as set forth below. For the purposes of illustration, levels of relationships can be ranging from 0 to 9; however, they can be implemented in any other formats (e.g., numerical, characters, or a combination of both). When two users: User A and User B join MUSTgate. The following tables would be created

| OBGR(A) | | | FBGR(A) | | |
|---|---|---|---|---|---|
| Owner | Friend | 0 | Friend | Owner | 0 |
| A | A | 9 | A | A | 9 |
| OBGR(B) | | | FBGR(B) | | |
| Owner | Friend | 0 | Friend | Owner | 0 |
| B | B | 9 | B | B | 9 |

Note that Trust Level of 9 is established in group 0 as default to allow a user to access his own files across multiple devices.
User A establishes a relationship with User B at trust level 4 and OBGR (A) is updated as follows:

OBGR(A)

| Owner | Friend | 0 | 1 |
|---|---|---|---|
| A | A | 9 | 9 |
| A | B | 0 | 4 |

User B establishes a relationship with User A at trust level 2 and the OBGR (B) is updated as follows:

OBGR(B)

| Owner | Friend | 0 | 1 |
|---|---|---|---|
| B | B | 9 | 9 |
| B | A | 0 | 2 |

As a result of these two OBGR updates (initiated by User A and subsequently by User B) the FBGR for both A and B would be updated as follows:

| FBGR(A) | | | | FBGR(B) | | | |
|---|---|---|---|---|---|---|---|
| Friend | Owner | 0 | 1 | Friend | Owner | 0 | 1 |
| A | A | 9 | 9 | B | B | 9 | 9 |
| A | B | 0 | 2 | B | A | 0 | 4 |

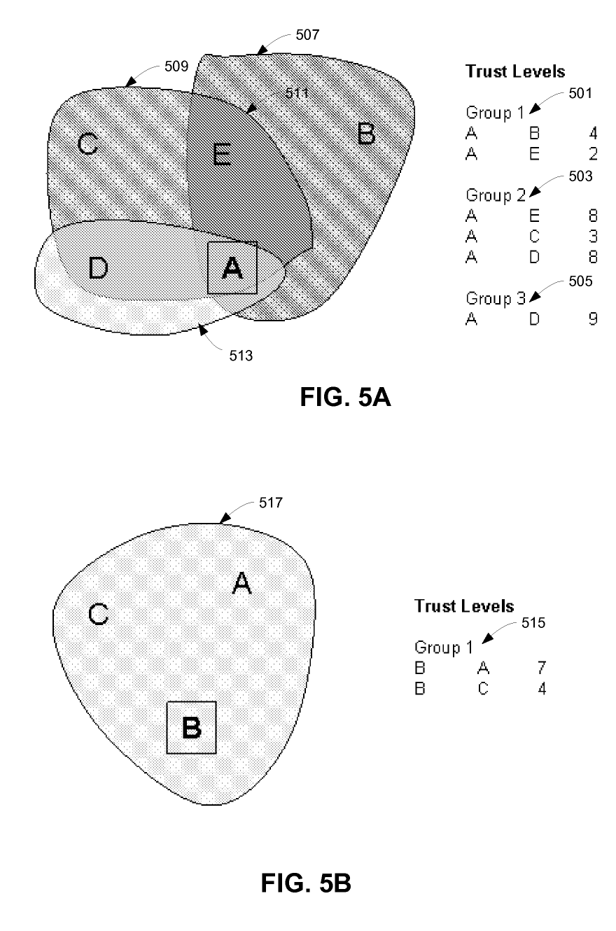

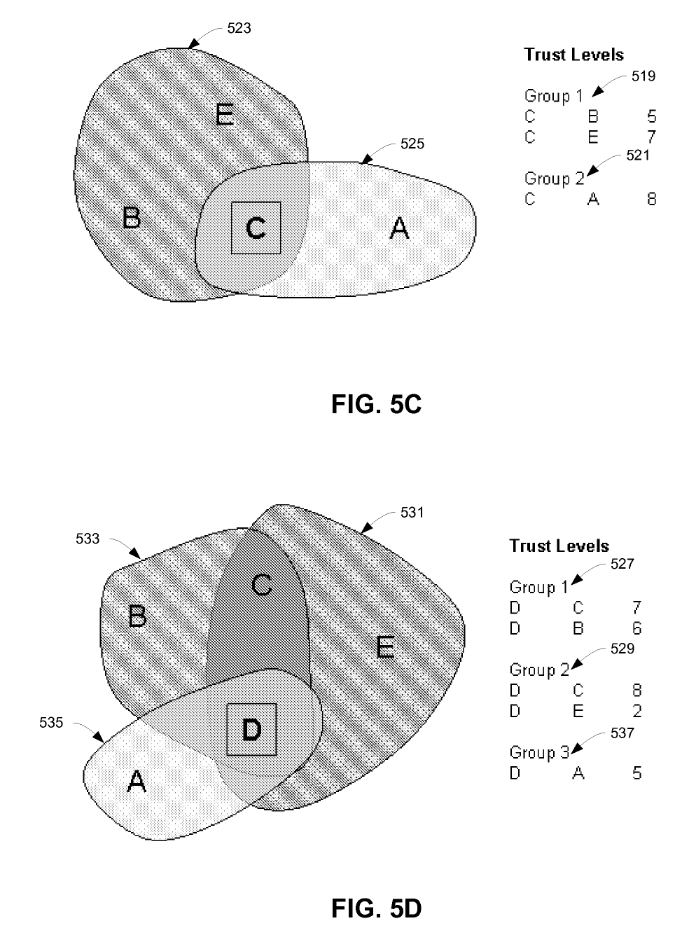

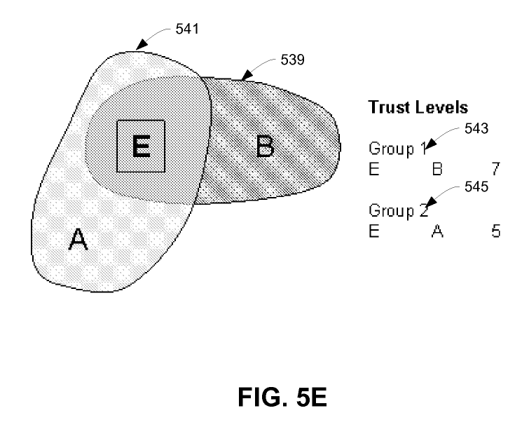

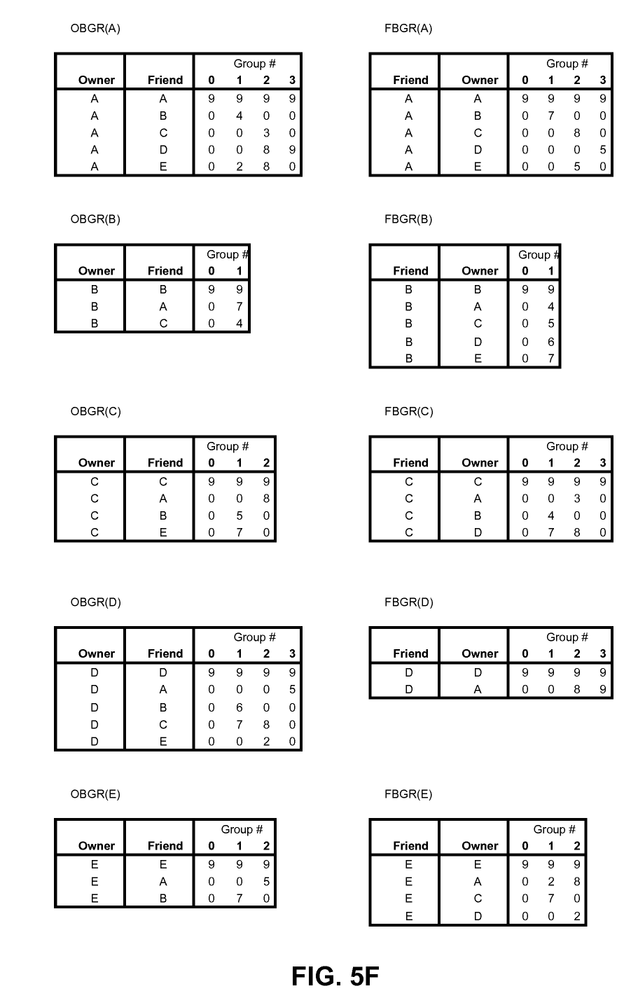

The logic above will continue to be followed as more users join, more groups are formed by individual users and more relationships are built. Consider the following point in time when there are a total of 5 users. The diagrams as shown in FIGS. 5A-5E illustrate the relationships and groups established by each user (A, B, C, D, and E). Based on the users, groups and relationships shown in FIGS. 5A-5E, the OBGR and FBGR tables would be established as shown in FIG. 5F.

In one embodiment, the FBGR may be used to determine which files a particular user can access. The owner, group, and trust fields that are associated with each file are used. MUSTgate is able to search for a particular file of a particular owner based on the group and trust level established in the FBGR.

A simple example would be for User D. Only one other user (e.g., User A) has established a relationship with D as shown in FBGR (D) of FIG. 5F. Note that this is completely independent from the fact that D has established relationships with other users. User D can only see information that he/she is qualified based on relationships established by other users. It is assumed that User A has posted the following files:

<file_name> [owner, group, privacy level, location, filetype]
<car_race.mp2> [A, 3, 5, \\alpha\beta\gamma, movie]
<hockey_payments.doc> [A, 1, 7, \\asd\asfdas\asdf, document]
<beach_picture.jpg> [A, 1, 1, \\ertre\erter\etert, image]
<beach_picture.jpg> [A, 2, 5, \\ertre\erter\etert, image]

Note in the above example, User A has posted the same file to two different groups at different trust levels for each group. This would be considered as two different files for the purposes of sharing. In one embodiment, these two different files may correspond to two different resource (or content) handles, while both handles pointing to the same physical file stored. Likewise, User A could have posted the same file with the same trust level to multiple groups. This would be managed the same way.

It is assumed that User D wants to see what files are available. Once user D is authenticated, the current FBGR for user D would be used to determine which files can be seen by user D using FBGR associated with user D. As shown in FBGR (D) of FIG. 5F, the first entry is files owned by User D and all groups trust level is 9. As a result, the system would show all files posted by User D to all groups (e.g., groups 1-4 in this example). This is a default condition allowing a particular user to see all files that he/she has posted. The second entry defines the relationship established by A with D. It shows that user D can access files posted by user A to group 2 with privacy level of 8 or below. Since user A also put user D in group 3, the FBGR also shows that user D can access files posted by user A in group 3 with privacy level of 9 or below. As a result, two searches are conducted on files owned by User A. First, all files owned by User A with group 2 and trust level of 8 or below would be shown. Second, all files owned by User A with group 3 and trust level of 9 or below would be shown.

As a result of the above searches, the following files would be made available (e.g., visible) to User D:
car_race.mp2
beach₁₃ picture.jpg

It is understood that both searches may return the same file. In the above examples if user D were a member of user A's groups 1 and 2 with a trust level higher than 5 in group 2, then they would be able to see “beach_picture.jpg” because they are part of group 1 and group 2. Note that the above examples are described for purposes of illustration only. Other processes or configurations may exist.

The above logic and processes may scale to the total number of users. Note that MUSTgate may maintain at least two tables for each user. In one embodiment, these tables may be derived from a common database. The first table (e.g., OBGR table) is updated in response to an action of the user itself (e.g., owner). The second table (e.g., FBGR table) is updated in response to an action of owners that have established a relationship with that particular user. In one embodiment, user actions may result in requests sent from a client device to a MUSTgate to update tables stored in a relationship data store. For example, a user may designate certain friends having different trust levels, which in turn may cause the corresponding tables to be updated. When a user wishes to access content through MUSTgate, the FBGR may be used as the basis to determine what content the user can see. In one embodiment, a content table such as one shown in FIG. 4C may be maintained for each owner that publishes content in one or more groups or communities with specified privacy levels associated with each file or content.

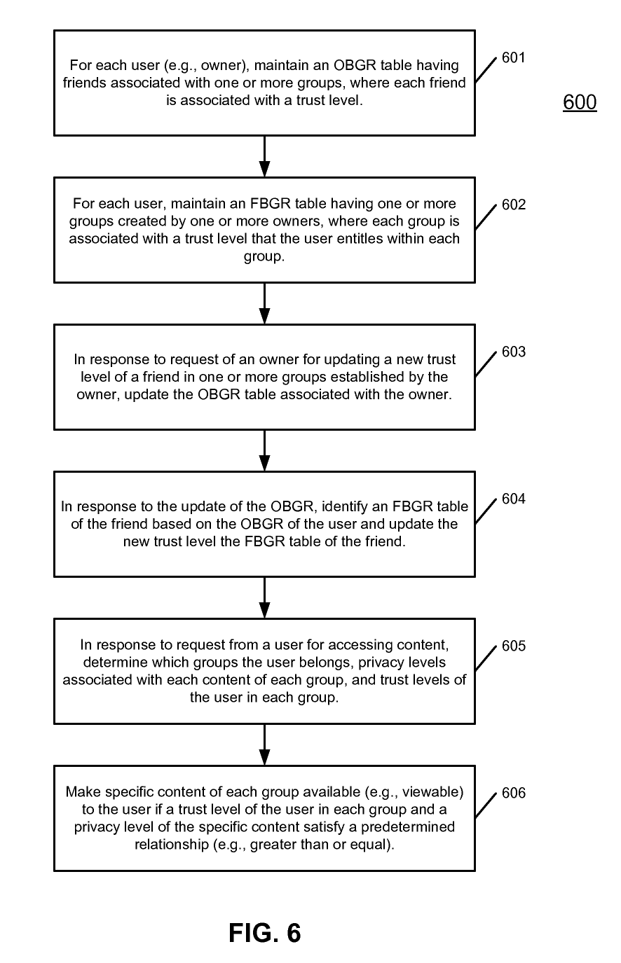

FIG. 6 is a flow diagram illustrating a process for sharing content among multiple users according to one embodiment of the invention. Note that process 600 may be performed by processing logic which may include software, hardware, or a combination of both. For example, process 600 may be performed by system 200 of FIG. 2. Referring to FIG. 6, at block 601, for each user from an owner point of view, an OBGR table is created and maintained. The OBGR table lists one or more friends of one or more groups created by the respective user as an owner, where each friend in each group is associated with a trust level assigned by the respective user as an owner. In addition, for each user from a friend point of view, at block 602, an FBGR table is created and maintained. The FBGR table lists one or more groups created by one or more owners, where each group is associated with a trust level of the user of which the user is a member.

At block 603, in response to a request of a user for updating a trust level of a friend in one or more groups created by the user as an owner, the system updates the OBGR table associated with the user. In addition, based on the OBGR table of the user, at block 604, an FBGR table of the friend is identified and the corresponding trust level or levels of the friend is updated accordingly. In response to a request from a user to see what files are available to access, at block 605, processing logic determines what files the user can access based on the trust levels and groups that owners have established with that particular user (from the FBGR). All files where the privacy level of each file and the trust level of the user satisfy a predetermined relationship (e.g., the trust level is greater than or equals to the privacy level), at block 606, will be made available to the user. That is, if a file published within a user group having a particular privacy level and a trust level of a user associated with the user group does not satisfy a predetermined relationship, that particular file is not available or visible to that particular user. That user may not be aware that file exists. Further, even if the privacy level of the file and the trust level of the user satisfy the predetermined relationship, as described above, the user may or may not know who the owner of that file is. Similarly, the user may or may not know which group or groups he/she belongs to as a member. What the user can see is the file is visible and accessible to him/her. Other operations may also be performed.

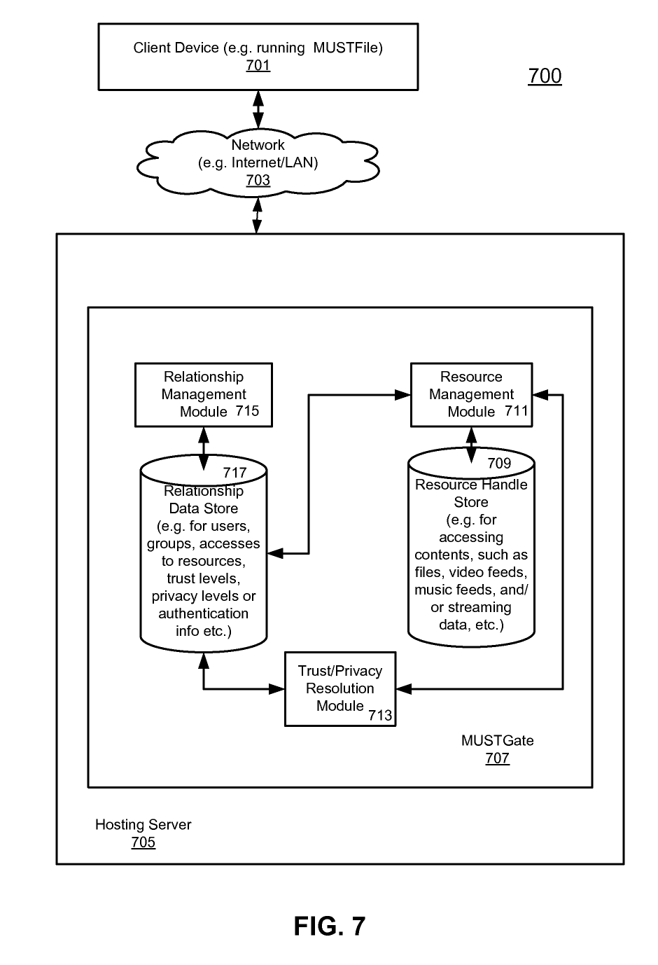

FIG. 7 is a block diagram illustrating an example of a networked system which may be used with one embodiment of the invention. System 600 may include one or more hosting servers 705 where MUSTgate (e.g. a software component in a server) 707 resides. A client device running MUSTfile (e.g. a software component in a client) 701 may interact with MUSTgate 707 remotely through a network 703, such as Internet, local/wide area network, or other network. MUSTfile 701 may communicate with MUSTgate 707 remotely via a network interface running in hosting servers 705 based on, for example, application programming interfaces (APIs). In one embodiment, MUSTgate 707 may provide services to other applications running in hosting servers 705 via an application programming interface (API).

MUSTgate 707 may include a relationship data store 717 for storing, for example, users, group memberships, resource handles for groups, privacy levels, trust levels etc. An entry in a relationship data store 717 may define a privacy level of content with respect to a group, or a trust level for a user as a member of a group. A relationship management module 715 may update a relationship data store 717 according to requests from a client, such as remotely received from MUSTfile 701 via a network interface. A client request received in MUSTgate 707 may result in creating a group stored in a relationship data store 717 for an owner, adding a member to a group, or setting a trust level of a member in a group by a group owner etc.

In one embodiment, MUSTgate 707 may include a resource handle store 709 for contents posted or published to groups as defined in a relationship data store 717. A content (or resource), e.g. files, streaming data sources, audio/video feeds etc., may be accessed via one or more handles stored in a resource handle store 709. A resource handle may include information on where and how to access a content, such as a pointer to a mass storage location where a file is stored, a network address to a remotely hosted file, an URL (universal resource locator) for the content, etc.

According to one embodiment, a trust/privacy resolution module 713 may determine whether a resource handle (or a handle to a content) in a resource handle store 709 is available for a member of a group based on, for example, trust levels and privacy levels defined in a relationship data store 717. In response to a content browsing request from a client, such as MUSTfile 701, a resource management module 711 may call (or send a request to) a trust/privacy resolution module 713 to select which content handles or resource handles stored in a resource handle store 709 to return to the client. A resource handle stored locally within a MUSTgate 707 may enable a remote client, such as MUSTfile 701, to retrieve the corresponding content from a hosting server, such as hosting server 705 for MUSTgate 707 or a separately located remote server.

In one embodiment, a MUSTgate 707 may include a resource management module 711 to update a resource handle store 709 in response to client requests, e.g. remotely from MUSTfile 701 or locally from other applications. A resource management module 711 may update both a resource handle store 709 and a relationship data store 717 in response to client requests for sharing contents to one or more groups. A resource management module 711 may monitor or detect whether a user posting content is live in a network 703 via a network interface. A resource management module 711 may download content from a remote location to be stored locally with MUSTgate 707 to generate a file path to the downloaded content available in a resource handle store 709. Alternatively, the content may be stored on the client machine of the owner and the content being shared may be downloaded on-demand or in a peer-to-peer networking environment.

In one embodiment, in response to a client request to retrieve a resource handle for a content, a resource management module 711 may be capable of updating the resource handle according to the requesting client (e.g. a MUSTfile 701), such as, for example, determining an active content server (or a peer server) hosting the corresponding content most close to the requesting client; or suggesting more than one active peer servers hosting the content for the requesting client to select from. In some embodiments, a resource management module 711 may perform content format conversion to download content to a requesting client based on the type of system platform hosting the requesting client. Prior to content downloading, authentication of a requesting client may be required via a resource management module 711 according to user authentication information stored, e.g. in a relationship data store 717. Note that some or all components as shown in FIG. 7 may be implemented in software, hardware, or a combination of both. Other configuration may also exist.

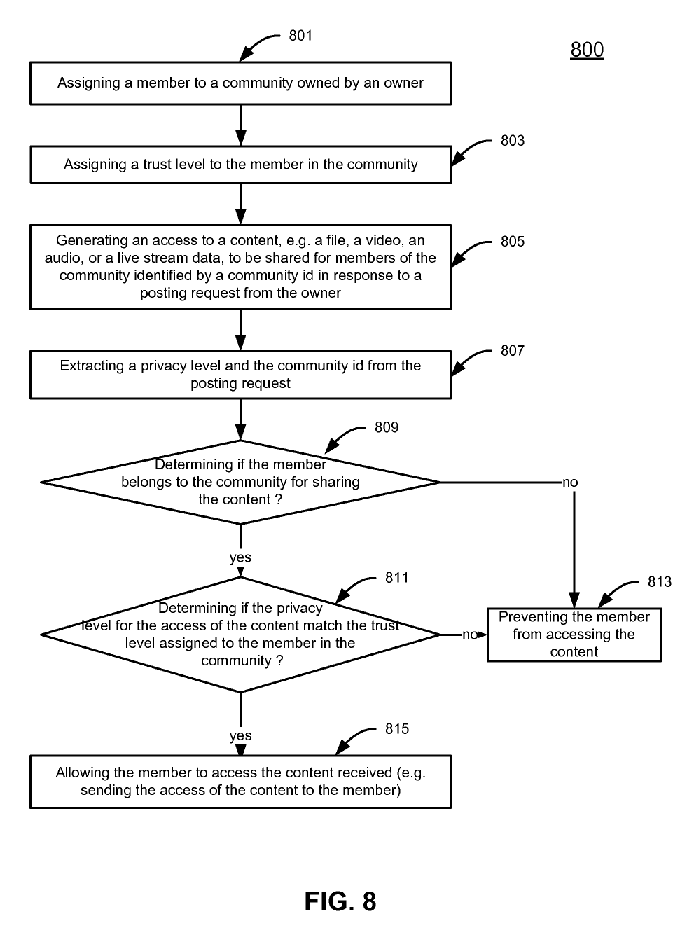

FIG. 8 is a flow diagram illustrating one embodiment of a process for sharing content with users. Exemplary process 800 may be performed by a processing logic that may comprise hardware (circuitry, dedicated logic, etc.), software (such as is run on a dedicated machine), or a combination of both. For example, process 800 may be performed by some components of system 700 of FIG. 7. In one embodiment, the processing logic of process 800 may assign a user to membership of a community (or user group) established or owned by an owner at block 801. The processing logic of process 800 may perform a membership assignment in response to receiving a request from a client, such as MUSTfile (e.g. 701 of FIG. 7). Ownership of a community may be verified against existing communities stored in a MUSTgate, such as in a relationship data store 717 of FIG. 7. In some embodiments, new groups and/or new members may be generated and stored on the fly during membership registration or assignment. At block 803, the processing logic of process 800 may assign a trust level for a member, such as, for example, a number within a predefined range with respect to a group the member belongs to. A trust level may be associated with a member and a group stored in a MUSTgate, such as, for example, a relationship data store 717 of FIG. 7.

At block 805, in one embodiment, the processing logic of process 800 may generate a handle to a resource (or content) in response to a posting request sent by the owner of certain content to share the content among members of the community. A handle of content may include authorization information (such as an URL with required access code) for retrieving content from a remote location, such as, for example, a networked server. In another embodiment, the processing logic of process 800 may download the content from a remote location to a local storage, e.g. a file in a local disk drive, coupled with a MUSTgate. A handle to content (or a resource handle) may include specifications for accessing the content, such as, for example, a network address, a path to a file, authorization information, or where to retrieve additional download information, etc. Contents for sharing may include live video/audio feeds, streaming data, or other data sources. In one embodiment, the processing logic of process 800 may generate a handle to content according to a posting request including corresponding specifications for accessing the content. The processing logic of process 800 may generate a handle to content as a path to a local file storing data retrieved from a remote location.

At block 807, in one embodiment, the processing logic of process 800 may extract a privacy level and a community (or group) identifier (id) from a posting request. A privacy level may be a number (e.g. an integer) within a predefined range. A privacy level may be assigned by an owner for a corresponding content to be shared in a community identified in a posting request. A privacy level may indicate a scope of secrecy perceived by an owner for content sharing among selected members of a community. At block 809, the processing logic of process 800 may determine if a member belongs to a community, for example, in response to a content browsing request from a client, such as MUSTfile 701 of FIG. 7.

According to some embodiments, the processing logic of process 800 may query a relationship data store (e.g. 717 of FIG. 7) according to a user identifier for a member and a community identifier for a community to determine if the user belongs to the community. A community may be associated with a list of user IDs stored in a relationship data store (e.g. 717 of FIG. 7) to define membership for the community. In one embodiment, a user belongs to a community (group) if the corresponding user id matches one of the lists of user IDs associated with the community.

If a user is determined to be a member of a community for sharing a content, at block 811, the processing logic of process 800 may determine if the privacy level associated with the content for the community, e.g. the privacy level extracted at block 807, matches the trust level assigned for the member in the community, e.g. the trust level assigned at block 803. A privacy level matches a trust level if a predefined relationship is satisfied. In one embodiment, a privacy level of content may match a trust level of a member if the privacy level is greater than or equal to a trust level. At block 815, if it is determined the privacy level of a content for a community matches the trust level of a member in the community, the processing logic of process 800 may allow the corresponding member to access the content, such as, for example, sending a response including a resource handle for the content.

In one embodiment, the processing logic of process 800 may retrieve a resource handle from a resource handle store (e.g. 709 of FIG. 7). In other embodiments, the processing logic of process 800 may collect handles to accessible contents for a particular member in response to a content browsing request. Otherwise, if a member does not belong to the community for sharing content such as determined at block 809, or the corresponding privacy level and trust level do not match, the processing logic of process 800 may hide the content from the requesting member. In one embodiment, a member may not be aware of the existence of the hidden content. In other embodiments, a member may receive a decline response when requesting a content hidden from being accessed by the member.

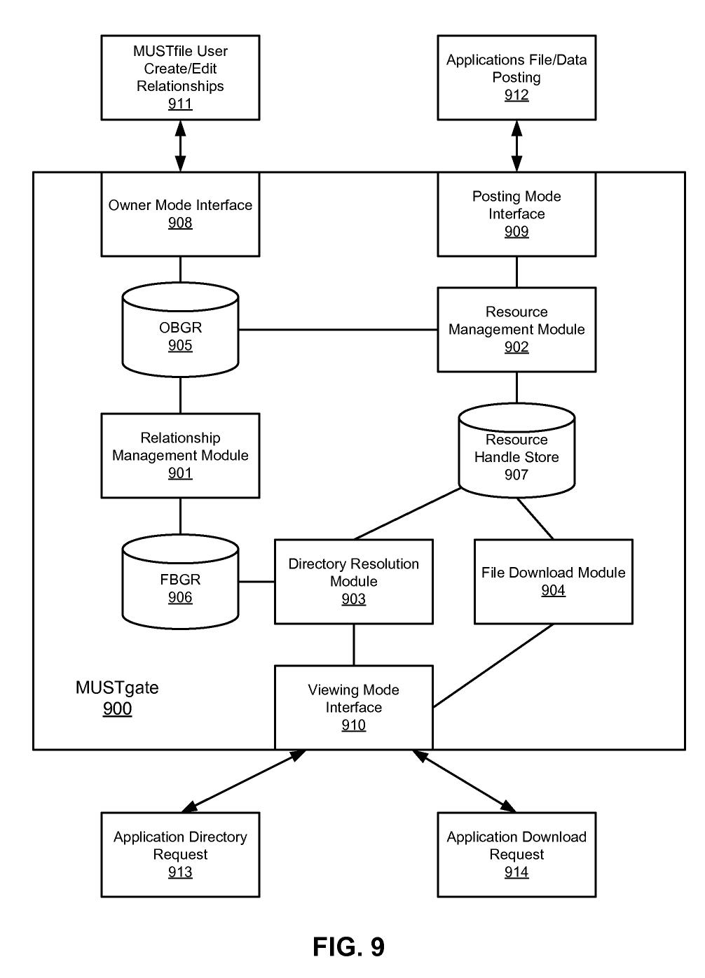

The user interface, for example in a MUSTFile 701 of FIG. 7, is intuitive and easy to use. It is built as a GUI that sits on a desktop of a computing device or fills the screen of a mobile device; this will define the size (although scalable) and shape of the interface. The user interface supports at least three modes: owner mode, viewing mode, and posting mode. FIG. 9 is a block diagram illustrating a server operating in different modes according to one embodiment of the invention. System 900 may be implemented as an alternative embodiment of system 700 of FIG. 7. Similar to the configuration as shown in FIG. 7, system 900 includes an OBGR 905, FBGR 906, resource management module 902, and relationship management module 901 having functionalities as described above. In addition, system 900 includes certain interfaces such as owner mode interface module 908, posting mode interface module 909, and viewing mode interface module 910 for operating in different modes.

The owner mode is used by an owner to establish relationships with other users and to establish groups. In the owner mode, an owner can also see status of previously established groups and relationships and modify them. The posting mode is also used by the owner for the purpose of posting files with appropriate privacy level to one or more groups. In the posting mode, the owner can also see status of previously posted files and modify them as necessary. In the viewing mode, a user is able to see what files are available and can choose to download, view, or stream the files as desired using directory resolution module 903 and file download module 904.

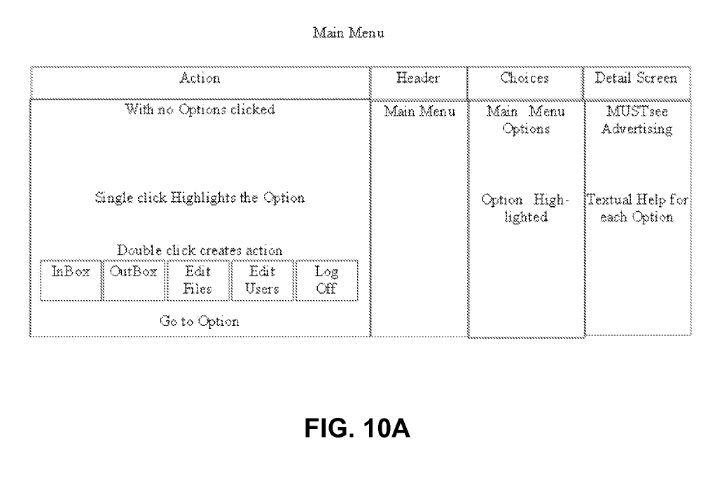

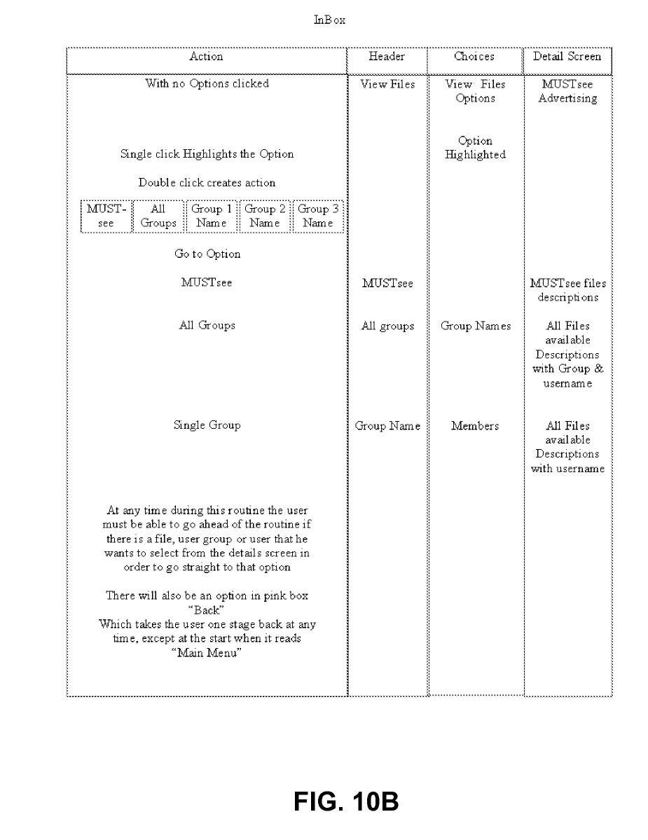

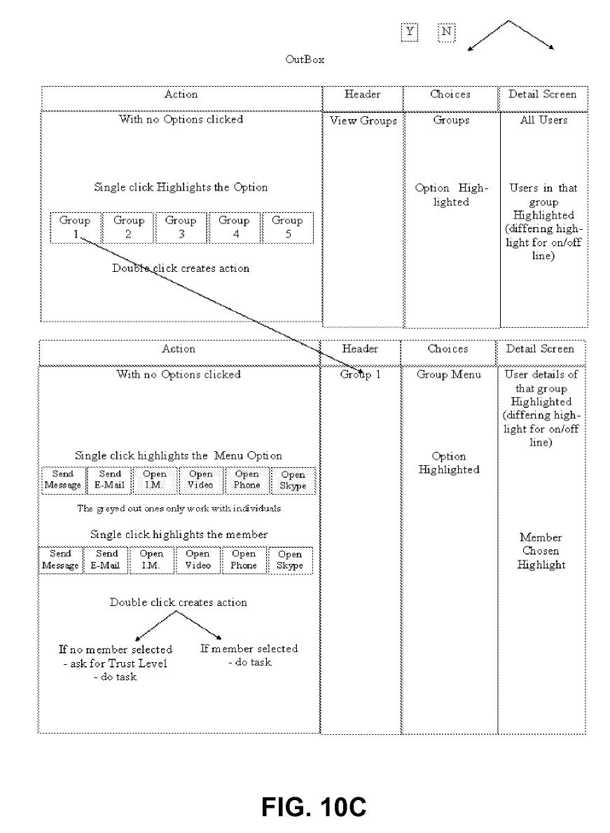

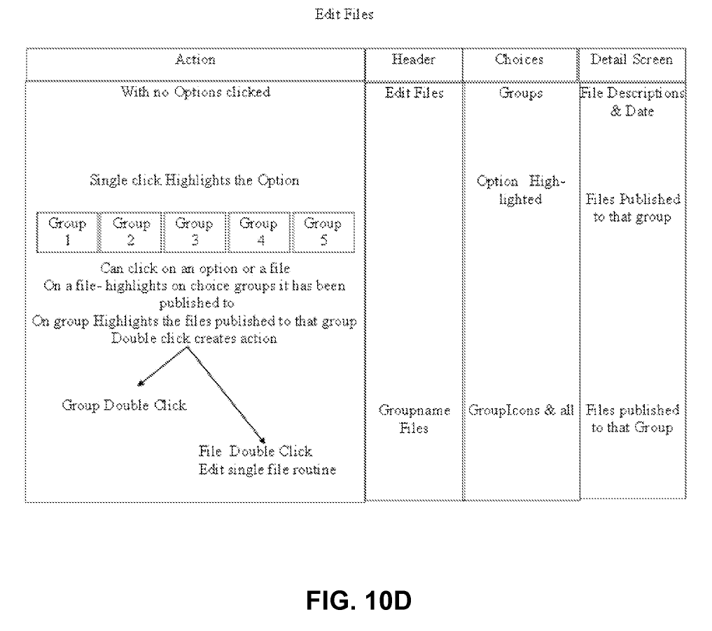

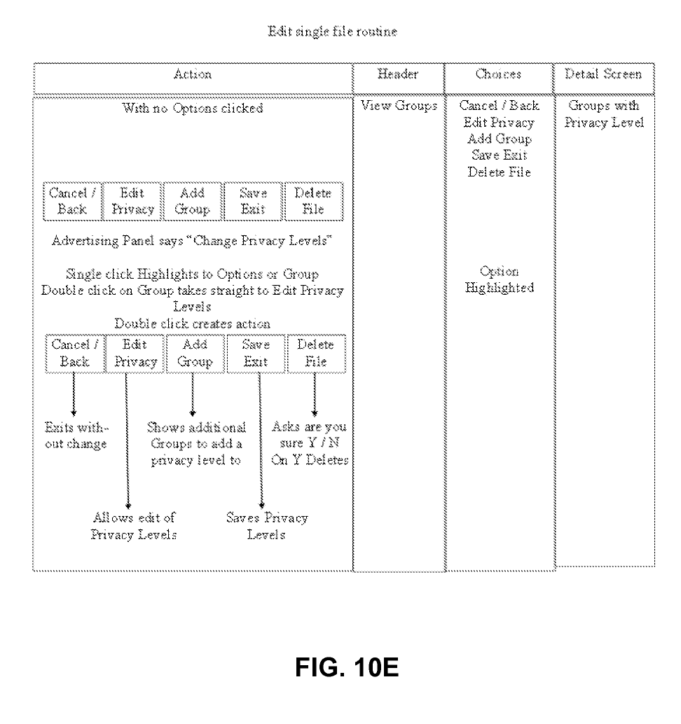

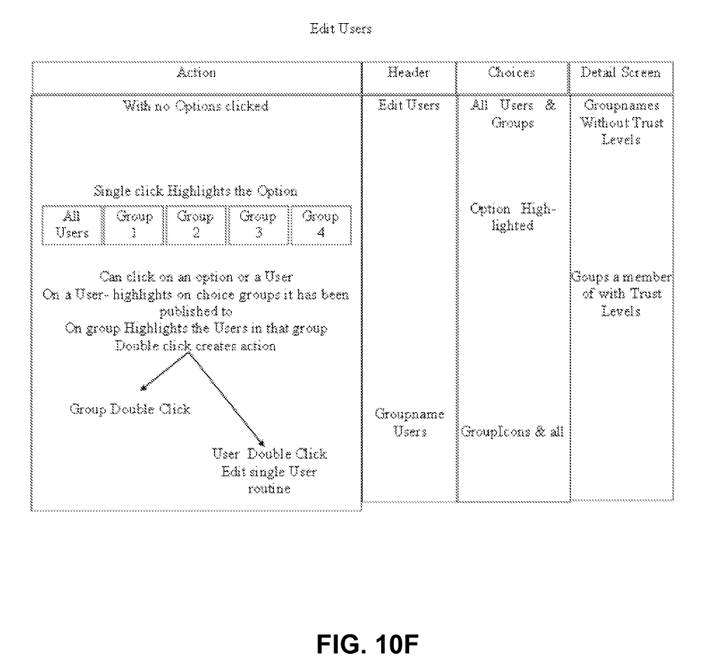

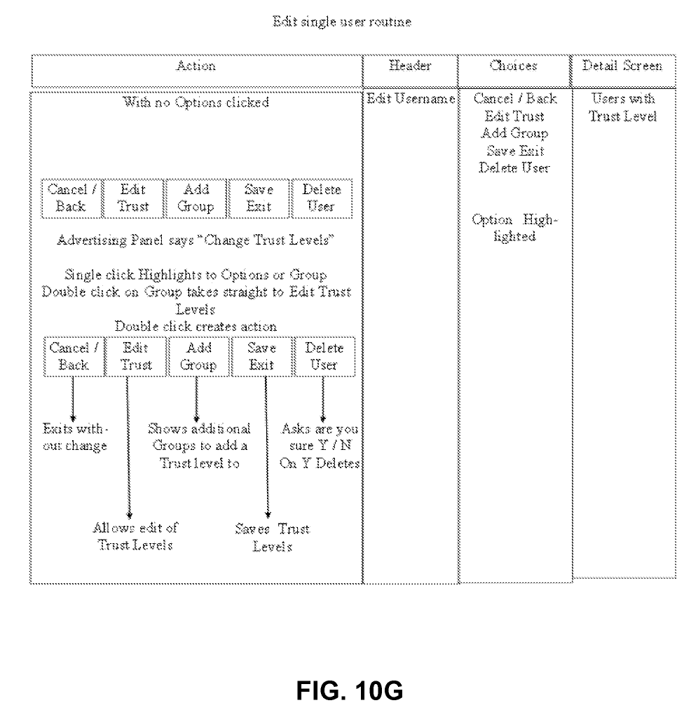

In one embodiment, the graphical user interface supports at least the following capabilities as shown in FIG. 10A:
Have basic graphical look and feel
Establish connectivity with MUSTgate
Provide ability for user to be authenticated by MUSTgate
Establish basic parameters about the device the user is currently connected to MUSTgate with such as:
   Type of device
   Current Network Connection
Run on a Windows XP based system
Run on a Windows Mobile based device
Other platforms to be added
Allow user to be on-line or off line
Look for non activity to take off-line (Preset in options)
Have Menu system to guide user
   InBox
   OutBox
   Edit Files
   Edit Users
   Options

In one embodiment, the owner mode supports at least the following capabilities allowing an owner to:

### Edit Users (As Shown in FIGS. 10F-10G):

View current user relationships and group assignments
Establish a new group
Establish a new relationship with a user
   Add that user to a group or groups
   Establish a trust level for that user within each group
Change the trust level or group assignment of an established user relationship
Allow multiple set-ups when the owner is joining an already set up “fixed” community
   The system must look for duplicates whilst doing this.
The system must also allow a user (Friend) to join an already set up group
   By setting him into a group
   Broadcasting to him the relevant information for the rest of the group.
Update MUSTgate of all changes

### Edit Files (As Shown in FIGS. 10D-10E):

View current files that the owner has posted along with the group and privacy level applied to each
Allow for on previously posted files
   Change of group assignment
   Change the privacy level in any assigned group
Delete posting of a file
Update MUSTgate of all change

### Options

Edit his platforms
Edit his Personal Information
Edit his Marketing Data

In one embodiment, the viewing mode supports at least the following capabilities allowing a user to:

### InBox Routines (As Shown in FIG. 10B):

See what files/content are available to be viewed
   Give indication whether file is currently available (owner on line)
   Have ability to buffer a file next time owner is on line
   Advise that a buffered file is now available
Sort available files by
   Group
   Owner (which friend posted the file)
   File type
   Date
Select a particular file and choose to:
   Download the file
   View the file
   Stream the file

### OutBox Routines (As Shown in FIG. 10C):

Allow outgoing immediate peer to peer communication
   Instant Messaging
   Instant Chat Room by selecting more than one friend
   Web cam
   Skype
   Video conferencing
Allow portal to other services
   SMS messaging
   Email
   Phone services—landline & mobile, dependent on platforms

In one embodiment, the posting mode supports at least the following capabilities allowing an owner to:
Accept any “drag and drop” from any Directory file.
Allow user to choose groups to allow access
Allow user to give differing Privacy level to each group chosen
Prompt for a description of the file from the user
Ensure above data has been collected
   If not go back through routine or cancel
Update MUSTgate with the relevant data

According to certain embodiments of the invention, initial users will be given a link to download a program. Personal data and marketing information will be collected as part of the download. The program will initiate itself and set up a directory in a directory of a local storage, for example, called “MUSTfile”. In a subdirectory if this directory it will set up a database which will collect all of the file information required by MUSTgate. This subdirectory may be called “Mustdata”.

In one embodiment, there are two groups set up automatically—“MustSee” and “Friends”. “MustSee” is used for marketing giving relevant information as well as having the help screens. “Friends” is the first group that users can use. A user will have a mechanism of inviting friends and acquaintances by invitation by pre-formatted email, which includes a Web page hyperlink for downloading the program together with a link back to his/her user ID.

Again, any alterations would be sent to MUSTgate. The user will have the ability to add groups or delete groups but not MustSee. The user may be prompted, on start-up of the system, for any friends that wish to connect to him/her. The user is able to enter other users into one or more groups with different (if appropriate) levels of trust in each group. There is a similar edit screen in order to change relationships and trust levels. MUSTfile sends a copy of Mustdata to the central server whenever there is an edit or update to any of this data.

In a particular embodiment, when opening the main MUSTfile window, a user may be prompted for a password. The computer may remember the password on stand-alone machines but not on multi-user ones. A format similar to a screen used in a PC version should be used later on much smaller screens. In one embodiment, the window may be split onto several sections:

| | |
|---|---|
| Top | Header |
| LHS | Choices with scroll bars |
| Yellow | Detail |
| Orange | Advertising space to be sold on non |
| | upgraded systems |
| Bottom | Controls such as Options (green) Back (purple) |
| | Enter (Black). These would tie up with instruction |
| | keys on mobile phone. |

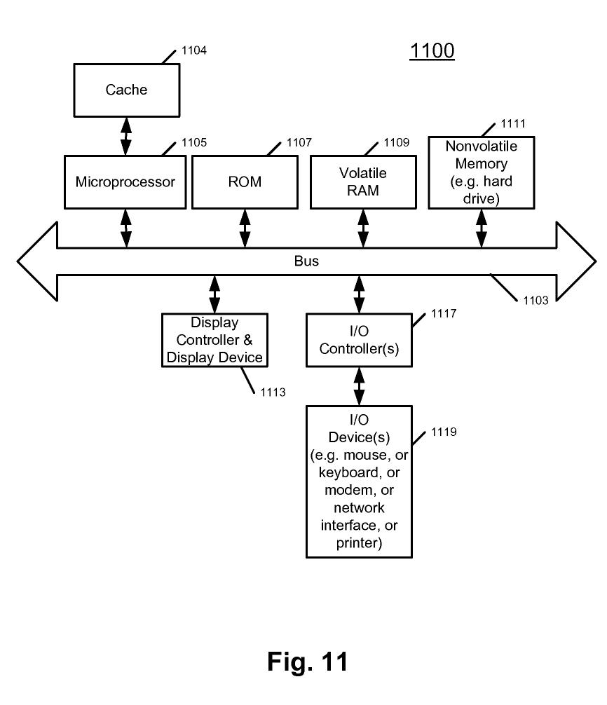

FIG. 11 shows one example of a computer system 1100 which may be used to implement an embodiment of the present invention. For example, system 1100 may be implemented as a server or a client of FIG. 2. Note that while FIG. 11 illustrates various components of a computer system, it is not intended to represent any particular architecture or manner of interconnecting the components as such details are not germane to the present invention. It will also be appreciated that network computers and other data processing systems which have fewer components or perhaps more components may also be used with the present invention.

As shown in FIG. 11, the computer system 1100, which is a type of a data processing system, includes a bus 1103 which is coupled to a microprocessor(s) 1105 and a ROM (Read Only Memory) 1107 and volatile RAM 1109 and a non-volatile memory 1111. The microprocessor 1103 may retrieve the instructions from the memories 1107 1109 1111 and execute the instructions to perform operations described above. The bus 1103 interconnects these various components together and also interconnects these components 1105, 1107, 1109, and 1111 to a display controller and display device 1113 and to peripheral devices such as input/output (I/O) devices 1119 which may be mice, keyboards, modems, network interfaces, printers and other devices which are well known in the art. Typically, the input/output devices 1115 are coupled to the system through input/output controllers 1117. The volatile RAM (Random Access Memory) 1109 is typically implemented as dynamic RAM (DRAM) which requires power continually in order to refresh or maintain the data in the memory.

The mass storage 1111 is typically a magnetic hard drive or a magnetic optical drive or an optical drive or a DVD RAM or other types of memory systems which maintain data (e.g. large amounts of data) even after power is removed from the system. Typically, the mass storage 1111 will also be a random access memory although this is not required. While FIG. 11 shows that the mass storage 1111 is a local device coupled directly to the rest of the components in the data processing system, it will be appreciated that the present invention may utilize a non-volatile memory which is remote from the system, such as a network storage device which is coupled to the data processing system through a network interface such as a modem or Ethernet interface. The bus 1103 may include one or more buses connected to each other through various bridges, controllers and/or adapters as is well known in the art.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Embodiments of the present invention also relate to an apparatus for performing the operations herein. This apparatus may be specially constructed for the required purposes, or it may comprise a general-purpose computer selectively activated or reconfigured by a computer program stored in the computer. Such a computer program may be stored in a computer readable medium. A machine-readable medium includes any mechanism for storing or transmitting information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices, etc.), a machine (e.g., computer) readable transmission medium (electrical, optical, acoustical or other form of propagated signals (e.g., carrier waves, infrared signals, digital signals, etc.)), etc.

The algorithms and displays presented herein are not inherently related to any particular computer or other apparatus. Various general-purpose systems may be used with programs in accordance with the teachings herein, or it may prove convenient to construct more specialized apparatus to perform the required method operations. The required structure for a variety of these systems will appear from the description below. In addition, embodiments of the present invention are not described with reference to any particular programming language. It will be appreciated that a variety of programming languages may be used to implement the teachings of embodiments of the invention as described herein.

In the foregoing specification, embodiments of the invention have been described with reference to specific exemplary embodiments thereof. It will be evident that various modifications may be made thereto without departing from the broader spirit and scope of the invention as set forth in the following claims. The specification and drawings are, accordingly, to be regarded in an illustrative sense rather than a restrictive sense.

What is claimed is:

1. A computer implemented method for sharing content among multiple users, the method comprising:
in response to a request received from a user to access content, determining one or more communities of which the user is a member, wherein each community is created by an owner, and wherein the content is published by the owner to be shared within the one or more communities;
if the user is a member of a community, determining if the user and the content satisfy a predefined relationship defined by the owner within the community;
causing the content available to the user for accessing if the user and the content satisfy the predefined relationship; and
preventing the user from accessing the content if the user and the content does not satisfy the predetermined relationship, wherein the content is invisible to the user if the user and the content does not satisfy the predetermined relationship.

2. The method of claim 1, wherein each member of the community is associated with a trust level previously assigned by the owner to represent a strength of a relationship with the owner within the community.

3. The method of claim 2, wherein the content is associated with a privacy level previously assigned by the owner of the content to represent a scope of secrecy within the community.

4. The method of claim 3, wherein the predetermined relationship is satisfied if the privacy level associated with the content being shared is less than the trust level associated with the user in view of the owner of the content.

5. The method of claim 1, further comprising receiving over a network a posting request from the owner to share the content among multiple members of one or more communities defined by the owner.

6. The method of claim 5, further comprising:
generating a handle of the content for accessing the content according to the posting request; and
extracting a community identifier and the privacy level from the posting request, wherein the handle of the content is associated with the community identifier identifying the community to share the content based on the privacy level.

7. The method of claim 6, wherein the request includes a user identifier identifying the user, wherein the method further comprises:
in response to a membership request from the owner, updating the members of the community to include the user, wherein the membership request includes the user identifier and the community identifier, and wherein the user identifier is associated with one or more community identifiers identifying one or more communities.

8. The method of claim 7, further comprising retrieving the one or more community identifiers according to the user identifier, wherein the content is determined to be shared in the community if the community identifier matches at least one of the one or more community identifiers.

9. The method of claim 8, wherein the request is to browse one or more contents including the content, further comprising:
retrieving community identifiers associated with the one or more contents; and
matching the one or more community identifiers with the community identifiers retrieved.

10. A machine-readable storage medium having instructions stored therein, which when executed by a machine, cause the machine to perform a method, the method comprising:
in response to a request received from a user to access content, determining one or more communities of which the user is a member, each community being created by an owner, wherein the content is published to be shared within the one or more communities by the owner;
if the user is a member of a community, determining if the user and the content satisfy a predefined relationship defined by the owner within the community;
causing the content available to the user for accessing if the user and the content satisfy the predefined relationship; and
preventing the user from accessing the content if the user and the content does not satisfy the predetermined relationship, wherein the content is invisible to the user if the user and the content does not satisfy the predetermined relationship.

11. The medium of claim 10, wherein each member of the community is associated with a trust level previously assigned by the owner to represent a strength of a relationship with the owner within the community.

12. The medium of claim 11, wherein the content is associated with a privacy level previously assigned by the owner to represent a scope of secrecy within the community.

13. The medium of claim 12, wherein the predetermined relationship is satisfied if the privacy level associated with the content being shared is less than the trust level in view of the owner of the content being shared.

14. The medium of claim 13, wherein the method further comprises:
receiving over a network a posting request from the owner to share the content among multiple members of one or more communities, wherein the owner is a member of the one or more communities.

15. The medium of claim 13, wherein the method further comprises:
generating a handle of the content for accessing the content according to the posting request; and
extracting a community identifier and the privacy level from the posting request, wherein the handle of the content is associated with the community identifier identifying the community to share the content based on the privacy level.

16. The medium of claim 15, wherein the request includes a user identifier identifying the user, wherein the method further comprises:
in response to a membership request from the owner, updating the members of the community to include the user, wherein the membership request includes the user identifier and the community identifier, and wherein the user identifier is associated with one or more community identifiers.

17. The medium of claim 16, wherein the method further comprises:
retrieving the one or more community identifiers according to the user identifier, wherein the content is determined to be shared in the community if the community identifier matches at least one of the one or more community identifiers.

18. The medium of claim 19, wherein the request is to browse one or more contents, wherein the method further comprises:
retrieving community identifiers associated with the one or more contents; and
matching the one or more community identifiers with the community identifiers retrieved.

19. An data processing system, comprising:
a processor;
a storage storing membership information and relationship information for a community created by an owner;
a memory storing executable codes including a management module and a resolution module, which when executed from the memory, cause the processor to perform a method, the method including,
in response to a request received from a user to access content, determining one or more communities of which the user is a member, each community being created by an owner, wherein the content is published to be shared within the one or more communities by the owner,
if the user is a member of a community, determining if the user and the content satisfy a predefined relationship defined by the owner within the community,
causing the content available to the user for accessing if the user and the content satisfy the predefined relationship, and
preventing the user from accessing the content if the user and the content does not satisfy the predetermined relationship, wherein the content is invisible to the user if the user and the content does not satisfy the predetermined relationship.

20. A computer-implemented method for sharing content among multiple users, the method comprising:
receiving over a network content from an owner to be shared among multiple members of one or more communities created by the owner;
determining a privacy level associated with the content to be shared, wherein the privacy level is assigned by the owner;
determining a trust level associated with each member of the one or more communities, wherein each member is associated with a trust level assigned by the owner previously to represent a relationship between each member and the owner; and
allowing sharing of the content among selected members of the one or more communities if trust levels of the selected members and the privacy level associated with the content satisfy a predetermined relationship.
